(19) United States
(12) Patent Application Publication
(10) Pub. No.: US 2025/0356383 A1
(43) Pub. Date: Nov. 20, 2025

(54) FEDERATED LEARNING MODEL GENERATION APPARATUS, FEDERATED LEARNING MODEL GENERATION SYSTEM, FEDERATED LEARNING MODEL GENERATION METHOD, COMPUTER-READABLE MEDIUM, AND FEDERATED LEARNING MODEL

(71) Applicant: NEC Corporation, Minato-ku, Tokyo (JP)

(72) Inventors: Takehiro KOZUSHI, Tokyo (JP); Hideki KOMORI, Tokyo (JP); Satoshi ODA, Tokyo (JP); Isamu TERANISHI, Tokyo (JP); Ryo FURUKAWA, Tokyo (JP)

(73) Assignee: NEC Corporation, Minato-ku, Tokyo (JP)

(21) Appl. No.: 18/864,085

(22) PCT Filed: May 25, 2023
(86) PCT No.: PCT/JP2023/019590

§ 371 Date: Nov. 8, 2024

(30) Foreign Application Priority Data
Jun. 1, 2022 (JP) 2022-089722

(51) Int. Cl. G06Q 30/0202; G06N 20/00; G06Q 30/0204

(52) U.S. Cl. CPC G06Q 30/02022; G06N 20/00; G06Q 30/0204

(57) ABSTRACT

Provided is a federated learning model, a generation apparatus thereof, and the like that easily and suitably contribute to marketing activities. A federated learning model generation apparatus includes a local learning model acquisition unit and a federated learning model generation unit. The local learning model acquisition unit acquires a plurality of different local learning models that have learned a relationship between a plurality of customer groups respectively generated from business customer data owned by a plurality of business operators and consumption behaviors corresponding to the business operators. The federated learning model generation unit receives a predetermined consumption behavior of a customer as input data by federating at least a part of the acquired local learning models, and generates a federated learning model that outputs prospective customer data for the input data.

### TECHNICAL FIELD

The present invention relates to a federated learning model generation apparatus, a federated learning model generation system, federated learning model generation method, a program, and a federated learning model.

### BACKGROUND ART

A business operator that provides products, services, and the like utilizes various market data to obtain business opportunities. In addition, a proposal is disclosed which uses a technique such as machine learning as a method of utilizing market data.

Patent Literature 1 discloses a technique in which a user behavior is predict using a user behavior history in a plurality of domains.

Patent Literature 2 discloses a technique in which a purpose of use of information registered by a plurality of business operators is received from a user, and the purpose of use is presented to an analyst who analyzes the information in accordance with the purpose of use.

Patent Literature 3 discloses a technique in which an initial learned model that controls a predetermined operation apparatus is incorporated into a plurality of operation apparatuses, and a plurality of individual learned models obtained by performing additional learning on the basis of individual operation data obtained by operating each operation apparatus are integrated.

### CITATION LIST

### Patent Literature

Patent Literature 1: Japanese Unexamined Patent Application Publication No. 2016-076097
Patent Literature 2: Japanese Unexamined Patent Application Publication No. 2019-046178
Patent Literature 3 Japanese Unexamined Patent Application Publication No. 2020-038699

### SUMMARY OF INVENTION

If there is an abundance of excellent data that serves as a basis for conducting marketing regarding behavior of a customer to purchase a product or behavior of using a service (that is, a predetermined consumption behavior), business operators can easily utilize this data for marketing. In this regard, a method can be considered which uses each other's customer data among a plurality of business operators. However, personal information of customers cannot be shared among the plurality of business operators.

In view of the problems described above, an object of the present disclosure is to provide a federated learning model, a federated learning model generation apparatus, and the like that easily and suitably contribute to marketing activities.

A federated learning model generation apparatus according to an aspect of the present disclosure includes a local learning model acquisition unit and a federated learning model generation unit. The local learning model acquisition unit acquires a plurality of different local learning models that have learned a relationship between a plurality of customer groups respectively generated from business customer data owned by a plurality of business operators and consumption behaviors corresponding to the business operators. The federated learning model generation unit receives a predetermined consumption behavior of a customer as input data by federating at least a part of the acquired local learning models, and generates a federated learning model that outputs prospective customer data for the input data.

In a federated learning model generation method according to an aspect of the present disclosure, a computer executes the following processes. The computer acquires a plurality of different local learning models that have learned a relationship between a plurality of customer groups respectively generated from business customer data owned by a plurality of business operators and consumption behaviors corresponding to the business operators. The computer receives a predetermined consumption behavior of a customer as input data by federating at least a part of the acquired local learning models, and generates a federated learning model that outputs prospective customer data for the input data.

According to an aspect of the present disclosure, there is provided a program for causing a computer to execute the following processes. The computer acquires a plurality of different local learning models that have learned a relationship between a plurality of customer groups respectively generated from business customer data owned by a plurality of business operators and consumption behaviors corresponding to the business operators. The computer receives a predetermined consumption behavior of a customer as input data by federating at least a part of the acquired local learning models, and generates a federated learning model that outputs prospective customer data for the input data.

According to the present disclosure, there can be provided a federated learning model, a generation apparatus thereof, and the like that easily and suitably contribute to marketing activities.

### BRIEF DESCRIPTION OF DRAWINGS

FIG. 1 is a block diagram of a data processing apparatus according to a first example embodiment.

FIG. 2 is a flowchart of a data processing method according to the first example embodiment.

FIG. 3 is a block diagram of a federated learning model generation apparatus according to the first example embodiment.

FIG. 4 is a flowchart of a federated learning model generation method according to the first example embodiment.

FIG. 5 is a block diagram of a data processing system according to a second example embodiment.

FIG. 6 is a block diagram of a data processing apparatus according to the second example embodiment.

FIG. 7 is a block diagram of a local data processing apparatus according to the second example embodiment.

FIG. 8 is a diagram illustrating processing of a business customer data generation unit.

FIG. 9 is a diagram illustrating business customer data.

FIG. 10 is a diagram illustrating processing of a local learning model.

FIG. 11 is a sequence diagram illustrating processing executed by a federated learning model generation system.

FIG. 12 is a diagram illustrating a configuration of a federated learning model.

FIG. 13 is a diagram illustrating processing of the federated learning model.

FIG. 14 is a sequence diagram illustrating processing executed by the data processing system.

FIG. 15 is a block diagram of a data processing apparatus according to a third example embodiment.

FIG. 16 is a block diagram of a local data processing apparatus according to the third example embodiment.

FIG. 17 is a sequence diagram of an update method according to the third example embodiment.

FIG. 18 is a block diagram exemplifying a hardware configuration of a computer.

### EXAMPLE EMBODIMENT

Hereinafter, the present invention will be described through example embodiments of the disclosure, but the disclosure according to the claims is not limited to the following example embodiments. Not all the configurations described in the example embodiments are essential as means for solving the problem. For clarity of description, the following description and drawings are omitted and simplified as appropriate. In each drawing, the same elements are denoted by the same reference numerals, and redundant description is omitted as necessary.

### First Example Embodiment

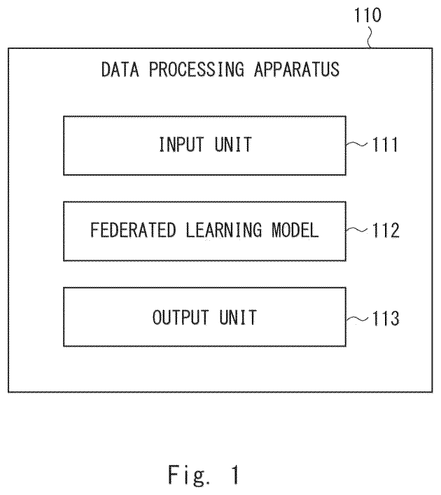

First, a first example embodiment of the present disclosure will be described. FIG. 1 is a block diagram of a data processing apparatus according to the first example embodiment. A data processing apparatus 110 illustrated in FIG. 1 receives input data regarding a predetermined consumption behavior, and outputs prospective customer data regarding the consumption behavior.

The predetermined consumption behavior is, for example, purchase of a product or a ticket, use of a service, or the like involving payment of money directly or indirectly. The prospective customer data is, for example, data in which a customer having a relatively high probability of performing the consumption behavior is defined by a predetermined segment. Specifically, the groups can be grouped by, for example, prospective customer data, age, gender, addresses, family structures, hobbies, occupations, medical histories, past consumption behavior histories, or the like. Accordingly, for example, the data processing apparatus 110 provides a predetermined business operator with data serving as a reference for deciding a segment of a customer to be a target for conducting a marketing activity. The marketing activity is an activity performed by a business operator, and includes activities such as sales, advertisement, and sales or provision of products or services to customers.

The data processing apparatus 110 can be configured by, for example, a computer, a server, or a dedicated device having a communication function. Note that in the following description, a “computer” may include any one of a server apparatus, a blade server, and a cloud computing system. The data processing apparatus 110 includes an input unit 111, a federated learning model 112, and an output unit 113 as main components.

The input unit 111 receives input data regarding a predetermined consumption behavior from a predetermined external apparatus or the like. The input data regarding the predetermined consumption behavior is, for example, data indicating a predetermined product or service. The input data regarding the consumption behavior may indicate detailed specifications of the product or the service.

The federated learning model 112 is generated such that at least a part of local learning models generated for a plurality of different business operators are federated. The “federation” in the present example embodiment means, for example, connecting data structures of a plurality of local learning models, but the definition of the federation is not limited thereto. The federated learning model 112 is generated by federating a plurality of local learning models to have the features of the local learning models. In addition, the federated learning model 112 is generated by federating the local learning models, so that it is possible to realize an algorithm that uses data of each of the plurality of local learning models in a cross-sectional manner. As the federation used in generating the federated learning model 112, various techniques known by those skilled in the art as “federated learning” may be employed. The federation may be paraphrased as, for example, integration.

The local learning model itself is one learning model. The local learning model is generated by learning a relationship between a plurality of customer groups respectively generated from business customer data owned by the business operators and consumption behaviors corresponding to the business operators.

The federated learning model 112 is set to be able to output the prospective customer data with respect to the input data received by the input unit 111. That is, for example, in a case where a consumption behavior of purchasing a predetermined product is received as input data, the federated learning model 112 outputs prospective customer data regarding a prospective customer who is relatively likely to purchase the product.

The output unit 113 outputs the prospective customer data output by the federated learning model 112 to the predetermined external apparatus described above or the like. The prospective customer data includes, for example, an index indicating a possibility that according to customer segments set in advance, a customer for each segment is a customer of the consumption behavior related to the input data.

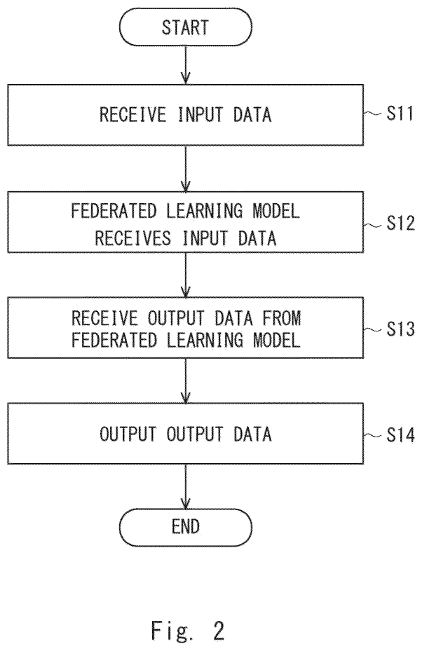

Next, processing performed by the data processing apparatus 110 will be described with reference to FIG. 2. FIG. 2 is a flowchart of a data processing method according to the first example embodiment. The flowchart illustrated in FIG. 2 is started, for example, by detecting that the federated learning model 112 has received input data.

First, the input unit 111 receives input data regarding a predetermined consumption behavior from an external apparatus or the like communicably connected to the data processing apparatus 110 (step S11). When receiving the input data, the input unit 111 supplies the received input data to the federated learning model 112.

Next, the federated learning model 112 receives the input data supplied from the input unit 111 (step S12). In other words, the data processing apparatus 110 supplies the input data received by the input unit 111 to the federated learning model 112.

Next, the federated learning model 112 outputs prospective customer data for the consumption behavior as an output for the input data. In other words, the data processing apparatus 110 receives the prospective customer data from the federated learning model 112 as an output (step S13).

Next, the output unit 113 outputs the prospective customer data received from the federated learning model 112 to a predetermined output destination (step S14). The output destination is, for example, an external apparatus that has received input data. When the output unit 113 outputs the output data, the data processing apparatus 110 ends a series of processing.

The data processing apparatus 110 has been described above. With the configuration described above, the data processing apparatus 110 can provide a data processing apparatus and the like that easily and suitably contribute to marketing activities.

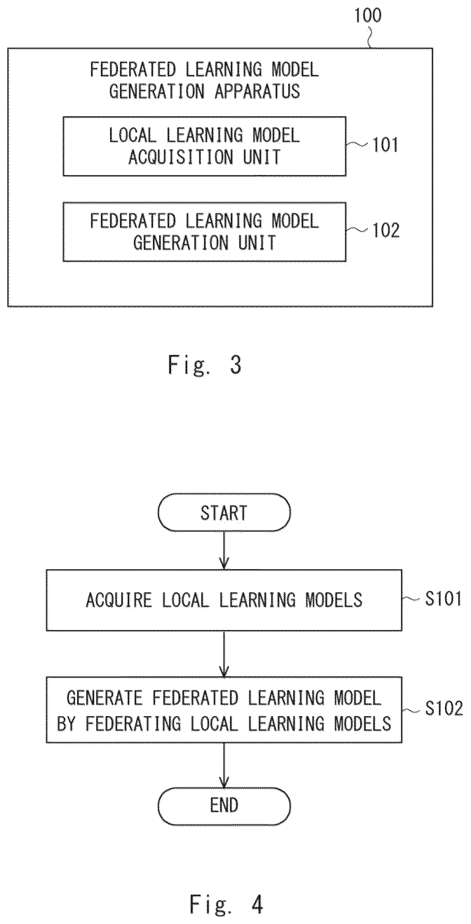

Next, an apparatus that generates the federated learning model 112 of the data processing apparatus 110 will be described with reference to FIG. 3. FIG. 3 is a block diagram of a federated learning model generation apparatus according to the first example embodiment.

A federated learning model generation apparatus 100 can be constituted by, for example, a computer or a dedicated device. The federated learning model generation apparatus 100 includes a local learning model acquisition unit 101 and a federated learning model generation unit 102.

The local learning model acquisition unit 101 acquires a plurality of different local learning models that have learned a relationship between a plurality of customer groups respectively generated from business customer data owned by a plurality of business operators and consumption behaviors corresponding to the business operators. The local learning model acquisition unit 101 acquires the local learning model from each business operator, for example, by communicably connecting to a computer of the business operator having the local learning model.

The federated learning model generation unit 102 federates at least a part of the acquired local learning models. Accordingly, the federated learning model generation unit 102 receives a predetermined consumption behavior of a customer as input data, and generates the federated learning model 112 that outputs prospective customer data for the input data.

Processing executed by the federated learning model generation apparatus 100 will be described with reference to FIG. 4. FIG. 4 is a flowchart of a federated learning model generation method according to the first example embodiment. The flowchart illustrated in FIG. 4 starts, for example, by detecting that the federated learning model generation apparatus 100 has acquired the local learning model.

First, the local learning model acquisition unit 101 acquires a plurality of different local learning models that have learned a relationship between a plurality of customer groups respectively generated from business customer data owned by a plurality of business operators and consumption behaviors corresponding to the business operators (step S101). The local learning model acquisition unit 101 supplies the acquired local learning model to the federated learning model generation unit 102.

Next, the federated learning model generation unit 102 generates a federated learning model by federating at least a part of the local learning models acquired by the local learning model acquisition unit 101 (step S102). The federated learning model 112 generated by the federated learning model generation unit 102 is set to receive a predetermined consumption behavior of a customer as input data and output prospective customer data for the input data.

When the federated learning model generation unit 102 generates the federated learning model 112, the federated learning model generation apparatus 100 ends a series of processing.

The federated learning model generation apparatus 100 has been described above. According to the configuration described above, it is possible to provide a federated learning model and a generation apparatus thereof that easily and suitably contribute to marketing activities.

The first example embodiment has been described above. Note that the data processing apparatus 110 and the federated learning model generation apparatus 100 may be separate apparatuses, or may be included in one apparatus or system.

Each of the data processing apparatus 110 and the federated learning model generation apparatus 100 includes a processor and a storage device as a configuration (not illustrated). The storage devices included in the data processing apparatus 110 and the federated learning model generation apparatus 100 include, for example, a storage device including a nonvolatile memory such as a flash memory or a solid state drive (SSD). In this case, the storage device stores a computer program (hereinafter, also simply referred to as a program) for executing the method described above. In addition, the processor reads the computer program from the storage device into a buffer memory such as a dynamic random access memory (DRAM), and executes the program.

Each configuration of the data processing apparatus 110 and the federated learning model generation apparatus 100 may be implemented with dedicated hardware. Some or all of the constituent elements may be implemented by general-purpose or dedicated circuitry, a processor, or the like, or a combination thereof. These constituent elements may be configured with a single chip or may be configured with a plurality of chips connected via a bus. Some or all of constituent elements of each apparatus may be implemented by a combination of the circuitry or the like described above and a program. Furthermore, as the processor, a central processing unit (CPU), a graphics processing unit (GPU), a field-programmable gate array (FPGA), or the like may be used. Note that the description regarding the configuration described here can also be applied to other apparatuses or systems described below in the present disclosure.

In addition, when some or all of the constituent elements of the data processing apparatus 110 and the federated learning model generation apparatus 100 are implemented by a plurality of information processing apparatuses, circuits, and the like, the plurality of information processing apparatuses, circuits, and the like may be arranged in a centralized manner or in a distributed manner. For example, the information processing apparatuses, the circuits, and the like may be implemented in the form of a client server system, a cloud computing system, or the like in which they are connected to each other via a communication network. The function of the information processing apparatus 10 may be provided in a software as a service (SaaS) format. In addition, the method described above may be stored in a computer readable medium to cause a computer to execute the method.

As described above, according to the present example embodiment, it is possible to provide a federated learning model that easily and suitably contributes to marketing activities, a generation apparatus thereof, a data processing apparatus using the federated learning model, and the like.

### Second Example Embodiment

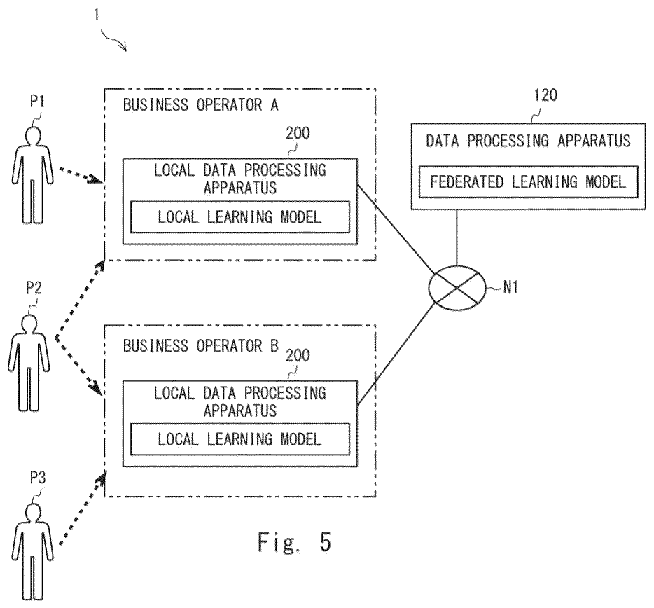

Next, an information processing system will be described with reference to FIG. 5. FIG. 5 is a block diagram of a data processing system 1 according to a second example embodiment. The data processing system 1 includes a data processing apparatus 120 and a plurality of local data processing apparatuses 200 as main components.

The data processing apparatus 120 illustrated in FIG. 5 is communicably connected to each of two local data processing apparatuses 200 via the network N1. One of the local data processing apparatuses 200 is owned by a business operator A. The other one of the local data processing apparatuses 200 is owned by a business operator B.

The business operator A is, for example, an automobile dealer. The business operator A uses the local data processing apparatus 200 owned by the business operator A for its own business. For example, a customer P1 and a customer P2 visit the business operator A for purchase of an automobile. Therefore, the business operator A acquires the personal information of the customer P1 and the customer P2.

The business operator B is, for example, a financial service operator that handles predetermined financial services and the like. The business operator B uses the local data processing apparatus 200 owned by the business operator B for its own business. For example, the customer P2 and a customer P3 visit the business operator B for a service contract. Therefore, the business operator B acquires the personal information of the customer P2 and the customer P3.

In the situation described above, the business operator A and the business operator B manage personal information (also referred to as customer information) of a customer in the local data processing apparatus 200. The customer information includes, in addition to personal information such as a name and an address of a customer, information on a consumption behavior such as a product purchased by the customer. The business operator A and the business operator B generate statistical data not including personal information from the customer information of each of the business operators A and B, and generate a local learning model from the statistical data. The business operator A and the business operator B supply the local learning models generated by the respective business operators to the data processing apparatus 120 via a network N1.

When receiving the local learning model from each of the business operator A and the business operator B, the data processing apparatus 120 federates the received local learning models to generate a federated learning model. The data processing apparatus 120 implements predetermined data processing by using the generated federated learning model. That is, the data processing apparatus 120 receives data regarding the consumption behavior of the customer as input data. Then, the data processing apparatus 120 outputs the prospective customer data for the received input data.

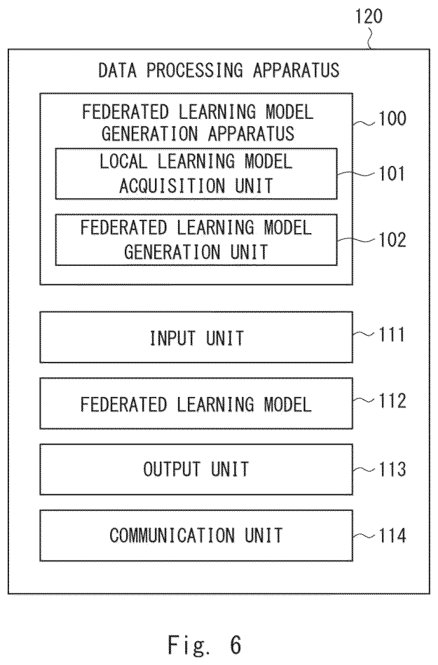

The data processing apparatus 120 will be further described with reference to FIG. 6. FIG. 6 is a block diagram of the data processing apparatus 120 according to the second example embodiment. The data processing apparatus 120 includes the federated learning model generation apparatus 100, the input unit 111, the federated learning model 112, the output unit 113, and a communication unit 114 as main components.

The federated learning model generation apparatus 100 has functions and configurations similar to the functions and configurations described in the first example embodiment. That is, the federated learning model generation apparatus 100 includes the local learning model acquisition unit 101 and the federated learning model generation unit 102 as main components.

The local learning model acquisition unit 101 according to the present example embodiment acquires the local learning model from the local data processing apparatus 200 included in each of the business operator A and the business operator B. The local learning model acquisition unit 101 supplies the plurality of acquired local learning models to the federated learning model generation unit 102.

The federated learning model generation unit 102 according to the present example embodiment generates the federated learning model 112 by federating the local learning models of the business operator A and the business operator B. More specifically, the federated learning model generation unit 102 generates a federated learning model by federating at least a part of the features extracted for the plurality of local learning models.

The input unit 111, the federated learning model 112, and the output unit 113 have functions and configurations similar to the functions and configurations described in the first example embodiment. The input unit 111 receives input data from, for example, the business person A or the business operator B.

The federated learning model 112 is the federated learning model generated by the federated learning model generation apparatus 100. That is, the federated learning model 112 according to the present example embodiment includes at least a part of the features of the local learning model generated by the business operator A and at least a part of the features of the local learning model generated by the business operator B.

The output unit 113 outputs the prospective customer data output by the federated learning model 112 to a predetermined output destination. The predetermined output destination is a supply source of the input data received by the input unit 111. For example, when receiving input data from the business operator A, the output unit 113 outputs output data to the business operator A. When receiving the input data from the business operator B, the output unit 113 outputs the output data to the business operator B.

The communication unit 114 includes an interface for connecting to the network N1. That is, the communication unit 114 receives various types of data from the local data processing apparatus 200 via the network N1. The communication unit 114 supplies the various types of received data to each configuration of the data processing apparatus 120. In addition, the communication unit 114 receives various types of data from each configuration included in the data processing apparatus 120, and supplies the received data to the local data processing apparatus 200 via the network N1.

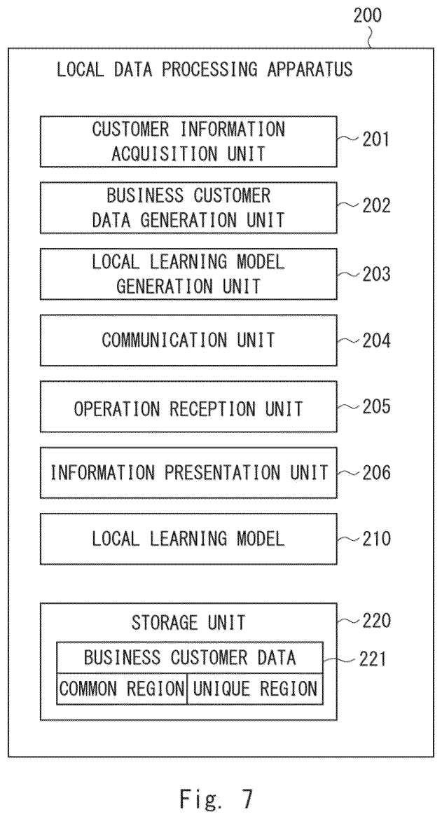

The local data processing apparatus 200 will be described with reference to FIG. 7. FIG. 7 is a block diagram of a local data processing apparatus according to the second example embodiment. The local data processing apparatus 200 includes a customer information acquisition unit 201, a business customer data generation unit 202, a local learning model generation unit 203, a communication unit 204, an operation reception unit 205, an information presentation unit 206, a local learning model 210, and a storage unit 220 as main components.

The customer information acquisition unit 201 acquires customer information of a business operator. The customer information may be information received via the operation reception unit 205 or may be information received via the communication unit 204. The customer information acquisition unit 201 supplies the received customer information to the business customer data generation unit 202.

The business customer data generation unit 202 receives customer information from the customer information acquisition unit 201, and generates business customer data 221 in a predetermined format from the received customer information. The business customer data 221 is statistical data that does not include specific personal information. The business customer data generation unit 202 stores the generated business customer data 221 in the storage unit 220.

The local learning model generation unit 203 generates the local learning model 210 from the business customer data 221 generated by the business customer data generation unit 202. At this time, the local learning model generation unit 203 generates a learning model by using a part of the business customer data 221 as input data and using another part of the business customer data 221 as output data.

In the generation of the learning model, various methods known in the field of machine learning can be adopted. For example, the local learning model may have a configuration called a decision tree, or may be configured by a predetermined neural network.

The communication unit 204 includes an interface for the local data processing apparatus 200 to connect to the network N1. That is, the communication unit 204 receives various types of data of the data processing apparatus 120 via the network N1. The communication unit 204 supplies the various types of received data to each configuration of the local data processing apparatus 200. In addition, the communication unit 204 receives various types of data from each configuration included in the local data processing apparatus 200, and supplies the received data to the data processing apparatus 120 via the network N1.

The operation reception unit 205 receives a predetermined operation performed by an administrator who manages the local data processing apparatus 200. The predetermined operation includes, for example, information and instructions input by an input apparatus such as a switch, a button, a keyboard, a mouse, a touch panel, or a remote controller. More specifically, for example, the operation reception unit 205 receives customer information by the input apparatus operated by the administrator, and supplies the received customer information to the customer information acquisition unit 201. Alternatively, the operation reception unit 205 receives predetermined input data regarding the local learning model from the administrator. When receiving the input data, the operation reception unit 205 supplies the input data to the local learning model 210. Alternatively, the operation reception unit 205 receives predetermined input data regarding the federated learning model from the administrator. When receiving the input data, the operation reception unit 205 supplies the input data to the data processing apparatus 120 via the communication unit 204.

The information presentation unit 206 is means for presenting information and the like regarding various types of processing performed by the local data processing apparatus 200 to the administrator or the like of the local data processing apparatus 200. Specifically, for example, the information presentation unit 206 is a display apparatus including a liquid crystal panel or organic electroluminescence. The information presentation unit 206 may present predetermined information to another device (a computer, a smartphone, or the like) via the communication unit 204.

The local learning model 210 is the learning model generated by the local learning model generation unit 203. The local learning model 210 is the learning model learned using the business customer data 221. For example, when receiving a predetermined customer group as an input, the local learning model 210 may output the consumption behaviors corresponding to the customer group. For example, when the consumption behavior of the business operator is received as an input, the local learning model 210 may output the customer group corresponding to the consumption behavior.

The storage unit 220 is a storage device including a nonvolatile memory such as a hard disk drive (HDD), a solid state drive (SSD), or a flash memory. The storage unit 220 stores the business customer data 221 generated by the business customer data generation unit 202. The business customer data 221 includes a common region commonly possessed by a plurality of business operators and a unique region possessed by each of the plurality of business operators.

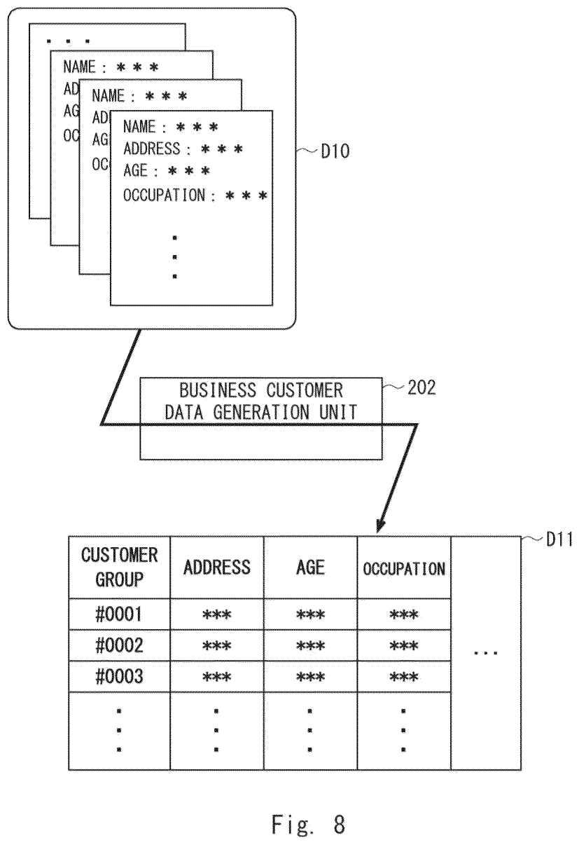

Next, the business customer data generation unit 202 will be described with reference to FIG. 8. FIG. 8 is a diagram illustrating processing of the business customer data generation unit 202. FIG. 8 illustrates customer information D10 input to the business customer data generation unit 202 and customer statistical data D11 output by the business customer data generation unit 202.

The customer information D10 includes a name, an address, an age, an occupation, and other personal information of the customer, and is information in which the customer is associated with unique information of the customer. In addition to the above items, the customer information D10 may include a family structure, a marriage history, a hobby, a taste, a behavior history, a product purchase history, and the like.

The customer statistical data D11 is information processed as statistical data by classifying the customer information D10 into predetermined categories and groups. The customer statistical data D11 does not include an individual name or information that can identify an individual. The customer statistical data D11 is grouped by, for example, an address in a predetermined range, an age in a predetermined range, an occupation in a predetermined classification, and the like as a customer group. Therefore, for example, a customer group #0001 includes a plurality of customers corresponding to the classification of the customer group #0001.

The business customer data generation unit 202 captures the customer information D10 and generates the customer statistical data D11 from the captured customer information D10. The customer statistical data D11 is classified by a definition common across a plurality of business operators. Therefore, “customer group #0001” is data classified by the common definition among a plurality of different business operators. In addition, the customer statistical data D11 does not include personal information. Therefore, the data processing system 1 can use the customer statistical data D11 across a plurality of business operators without providing the customer information managed by each of the business operators to others.

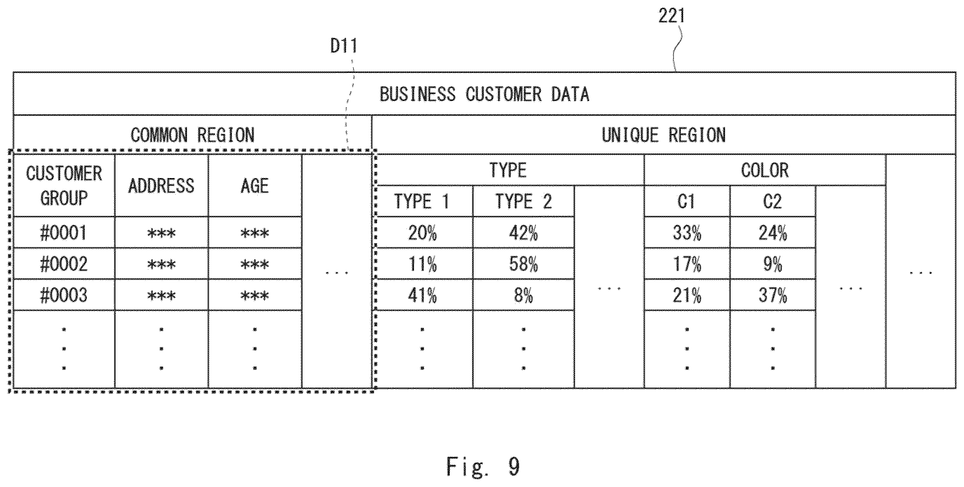

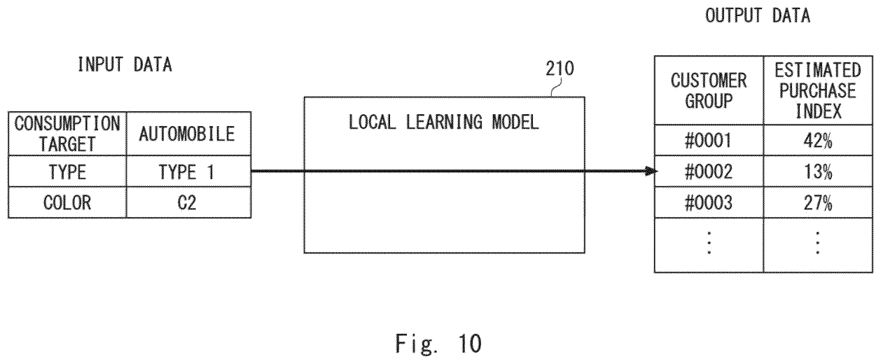

Next, the business customer data will be described with reference to FIG. 9. FIG. 9 is a diagram illustrating the business customer data 221. The business customer data 221 has the customer statistical data D11 described in FIG. 8 as a common region. The common region refers to a data region set by a definition common across a plurality of different business operators in the data processing system 1. The common region includes a customer group.

The business customer data 221 includes a unique region in addition to the common region. The unique region includes unique data regarding the business of the business operator, and is associated with the customer statistical data D11 of the common region. For example, in the customer group #0001 illustrated in FIG. 9, the purchase index of a product type 1 is 20%, the purchase index of a product type 2 is 42%, and the like. The purchase index is statistics of consumption behaviors of customers belonging to a customer group.

The purchase index may be a probability as illustrated in FIG. 9 or may be a rank, a score, or the like as long as the federated learning model generation apparatus 100 can generate a federated learning model. That is, the business customer data 221 includes a customer group included in the business customer data and a consumption behavior associated with the customer group.

The local learning model generation unit 203 according to the present example embodiment generates the local learning model 210 by using the business customer data 221 as illustrated in FIG. 9. That is, the local learning model generation unit 203 generates a local learning model learned on the basis of business customer data including a common region commonly possessed by a plurality of business operators and a unique region possessed by each of the plurality of business operators.

Alternatively, the local learning model generation unit 203 generates a local learning model learned on the basis of the business customer data including the customer group as the common region. In addition, the local learning model generation unit 203 generates a local learning model having, as the common region, data obtained by classifying customers into a plurality of groups, as the customer group, on the basis of a predetermined attribute regarding the customers.

Next, processing of the local learning model 210 will be described with reference to FIG. 10. FIG. 10 is a diagram illustrating the processing of the local learning model. The local learning model 210 illustrated in FIG. 10 is a local learning model of the business operator A. The local learning model 210 receives, as input data regarding the consumption behavior of the customer, data in which the type of the automobile is type 1 and the color is C2. When receiving the input data, the local learning model 210 outputs, as output data corresponding to the input data, the purchase index for each customer group. As described above, when receiving, as the input, the consumption behavior of the business operator, the local learning model 210 outputs the customer groups corresponding to the consumption behavior.

Note that the processing performed by the local learning model 210 is not limited to the above content. For example, the local learning model 210 may output the consumption behaviors corresponding to the customer group when receiving the customer group as the input.

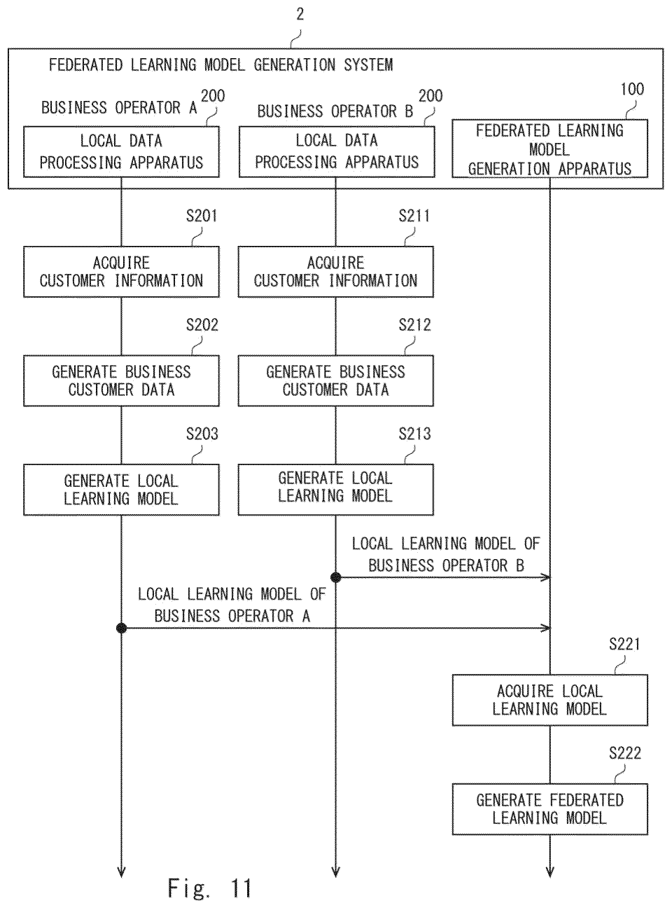

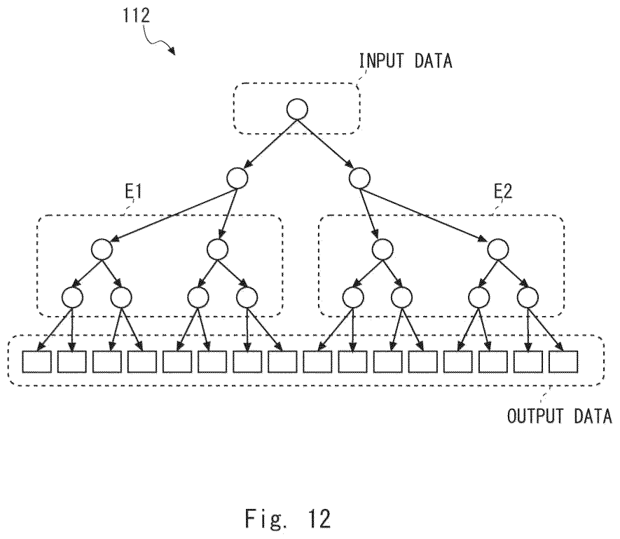

Next, processing of generating a federated learning model will be described with reference to FIG. 11. FIG. 11 is a sequence diagram illustrating processing executed by a federated learning model generation system. FIG. 11 illustrates, as a configuration for generating a federated learning model, the local data processing apparatus 200 included in the business operator A, and the local data processing apparatus 200 and the federated learning model generation apparatus 100 included in the business operator B as a federated learning model generation system 2.

That is, the federated learning model generation system 2 includes a plurality of local data processing apparatuses 200 and the federated learning model generation apparatus 100. The local data processing apparatus 200 generates the local learning model 210 for each business operator from the business customer data managed by each business operator. The federated learning model generation apparatus 100 acquires the local learning models 210 from each of a plurality of business operators to generate the federated learning model 112.

In the sequence diagram illustrated in FIG. 11, the local data processing apparatus 200 of the business operator A first acquires customer information (step S201). Next, the local data processing apparatus 200 of the business operator A generates business customer data from the acquired customer information (step S202). Further, the local data processing apparatus 200 of the business operator A generates a local learning model from the business customer data (step S203).

Similarly to the case of the business operator A, the local data processing apparatus 200 of the business operator B also first acquires customer information (step S211), and further generates business customer data (step S212). Then, the local data processing apparatus 200 of the business operator B generates a local learning model from the generated business customer data (step S213).

Next, the federated learning model generation apparatus 100 acquires the local learning model of the business operator A and the local learning model of the business operator B (step S221). Then, the federated learning model generation apparatus 100 generates a federated learning model by federating the acquired local learning models (step S222).

The federated learning model generation system 2 has been described above with reference to FIG. 11. As described above, the federated learning model generation apparatus 100 cooperates with the local data processing apparatus 200 to constitute the federated learning model generation system 2.

Next, a configuration of the federated learning model will be described. FIG. 12 is a diagram illustrating the configuration of the federated learning model. The federated learning model 112 illustrated in FIG. 12 is an example constructed using a decision tree. When receiving input data, the federated learning model 112 illustrated in FIG. 12 processes the input data by a plurality of constructed nodes. Then, the federated learning model 112 outputs output data illustrated at the bottom in FIG. 12. Note that the diagram illustrated in FIG. 12 schematically illustrates the data structure of the decision tree, and the number of nodes, the number of layers, and the like are not limited to the configuration of FIG. 12.

The federated learning model 112 has an element E1 and an element E2. The element E1 includes at least a part of the features of the local learning model 210 of the business operator A. The element E2 includes at least a part of the features of the local learning model 210 of the business operator B. As described above, the federated learning model 112 is generated by extracting at least a part of the features of each of the local learning models and federating the extracted features. In other words, the federated learning model generation unit 102 of the federated learning model generation apparatus 100 generates the federated learning model 112 by federating at least a part of the features extracted for each of the plurality of local learning models.

Note that although FIG. 12 illustrates an example of the decision tree, the federated learning model 112 included in the data processing system 1 is not limited to the decision tree. The federated learning model 112 may have a predetermined perceptron or neural network as a configuration.

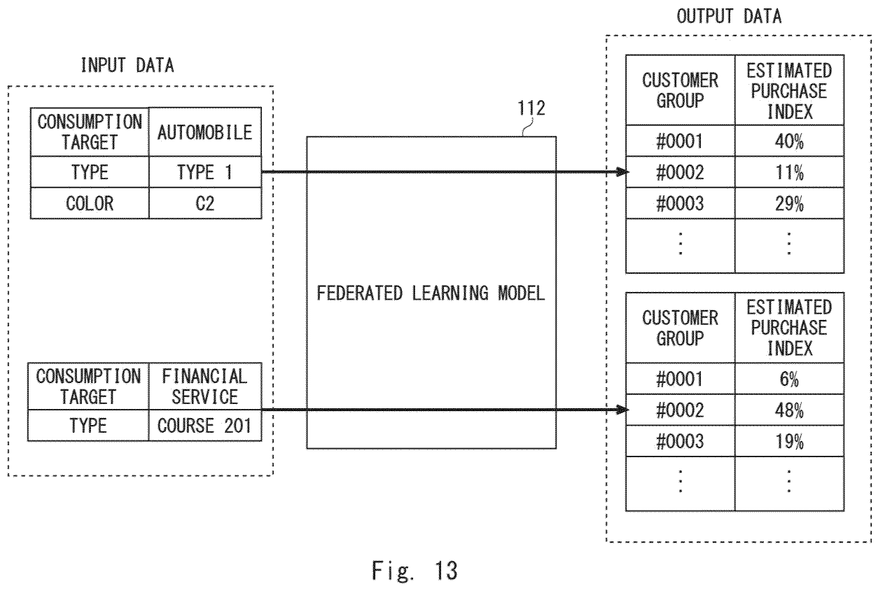

Next, processing executed by the federated learning model 112 will be described with reference to FIG. 13. FIG. 13 is a diagram illustrating processing of the federated learning model. The federated learning model 112 illustrated in FIG. 13 is generated by federating the local learning model of the business operator A and the local learning model of the business operator B. Therefore, the federated learning model 112 can receive, as input data, data regarding a consumption behavior regarding the business of the business operator A, and can also receive data regarding a consumption behavior related to the business of the business operator B.

In the upper part of FIG. 13, the federated learning model 112 receives input data regarding consumption behaviors of automobiles related to the business of the business operator A. In this case, the federated learning model 112 outputs the purchase index for each customer group as output data corresponding to the received type and specification of the automobile.

In the lower part of FIG. 13, the federated learning model 112 receives input data regarding consumption behaviors of financial services related to the business of the business operator B. In this case, the federated learning model 112 outputs the purchase index for each customer group as output data corresponding to the received specification of the financial service.

In this manner, the federated learning model 112 receives input data regarding a consumption behavior of each of a plurality of businesses, and outputs prospective customer data corresponding to the received input data. The federated learning model 112 is set to be capable of, when receiving input data regarding a predetermined consumption behavior, outputting prospective customer data for the consumption behavior. At this time, the business customer data of the business operator A, the business customer data of the business operator B, and the prospective customer data output by the federated learning model 112 each include a customer group common to them. The federated learning model 112 outputs prospective customer data including at least a part of a plurality of customer groups. At this time, the federated learning model 112 may output prospective customer data including an estimated purchase index indicating the tendency of the consumption behaviors of the customer groups.

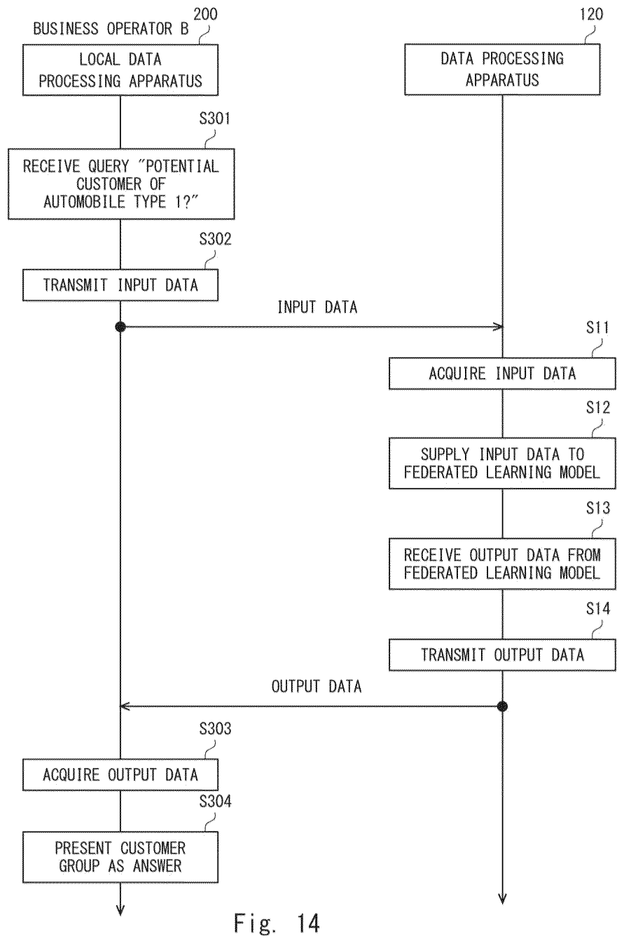

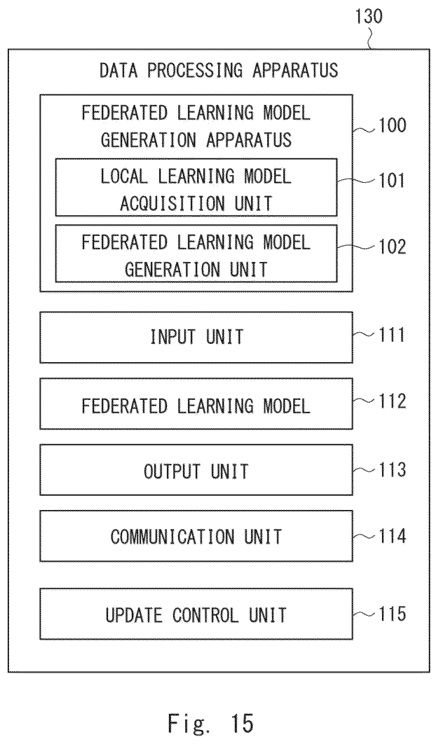

Next, processing executed by the data processing system 1 will be described with reference to FIG. 14. FIG. 14 is a sequence diagram illustrating processing executed by the data processing system 1. The sequence diagram illustrated in FIG. 14 illustrates a flow in which the local data processing apparatus 200 of the business operator B, which is a financial service operator, receives input data for the federated learning model 112, and the federated learning model 112 outputs, to the local data processing apparatus 200, output data as a response to the input data.

First, the local data processing apparatus 200 receives a predetermined query from a user who is a user of the data processing system 1 (step S301). The query has content of “potential customer of automobile type 1?”, for example.

Next, the local data processing apparatus 200 generates input data to be transmitted to the data processing apparatus 120 from the content of the query, and transmits the generated input data to the data processing apparatus 120 (step S302).

Next, the data processing apparatus 120 acquires the input data from the local data processing apparatus 200 (step S11), and supplies the acquired input data to the federated learning model 112 (step S12).

When receiving the input data, the federated learning model 112 outputs prospective customer data that is output data corresponding to the received input data. The data processing apparatus 120 receives the output data from the federated learning model 112 (step S13) and transmits the received output data to the local data processing apparatus 200 (step S14).

Next, the local data processing apparatus 200 acquires the output data from the data processing apparatus 120 (step S303), and presents an answer to the user by using the acquired output data (step S304). The answer includes a customer group.

The processing executed by the data processing system 1 has been described above. In the data processing system 1, the federated learning model 112 that has received the input regarding the consumption behavior outputs the prospective customer. In the federated learning model, personal information is not used, but information on customer groups grouped according to a predetermined standard is handled. Therefore, the data processing system 1 can associate data of unique regions of different business operators with each other via data of the common region by the federation learning. Therefore, the data processing system 1 can output, to each business operator, prospective customer data using data of a common region across a plurality of business operators. That is, the data processing system 1 can estimate the prospective customer data regarding the business of each business operator with high accuracy.

In addition, as illustrated in FIG. 14, the data processing system 1 can transmit a query to the data processing apparatus 120 using, as input data, a consumption behavior related to a business different from its own business, and obtain prospective customer data to be an answer to the query. Accordingly, the business operator using the data processing system 1 can acquire prospective customer data regarding a consumption behavior that is difficult to acquire from its own business. Therefore, the data processing system 1 can contribute to expanding a range of marketing activities of the business operator.

Note that the administrator who manages the data processing apparatus 120 may be the business operator A or the business operator B, or may be a person different from the business operator A and the business operator B. The administrator of the data processing apparatus 120 may have the federated learning model 112.

As described above, according to the second example embodiment, it is possible to provide a federated learning model that easily and suitably contributes to marketing activities, a generation apparatus thereof, a data processing apparatus using the federated learning model, and the like.

### Third Example Embodiment

Next, a third example embodiment will be described. The third example embodiment is different from the example embodiments described above in that the third example embodiment has a function of updating the local learning model and the federated learning model.

FIG. 15 is a block diagram of a data processing apparatus 130 according to the third example embodiment. The data processing apparatus 130 illustrated in FIG. 15 is different from the data processing apparatus 120 described above in that the data processing apparatus 130 includes an update control unit 115.

The update control unit 115 controls acquisition of the local learning model when the local learning model is updated. Specifically, the update control unit 115 appropriately acquires update information from a plurality of local data processing apparatuses. Then, when it is detected that the local learning model has been updated, the local learning model acquisition unit 101 is instructed to acquire update data from the local data processing apparatus having the updated local learning model.

In addition, the update control unit 115 controls updating of the federated learning model by using the updated local learning model. That is, the update control unit 115 instructs the federated learning model generation unit 102 to update the federated learning model by using the acquired update data.

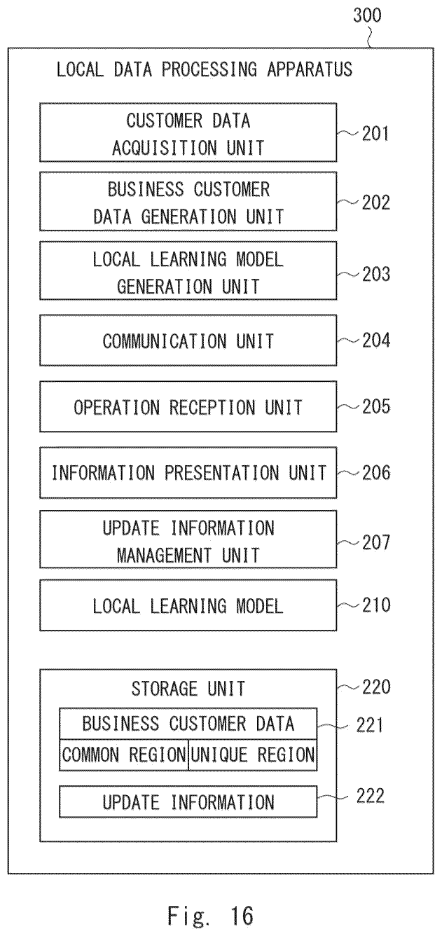

FIG. 16 is a block diagram of a local data processing apparatus 300 according to the third example embodiment. The local data processing apparatus 300 is different from the local data processing apparatus 200 described above in that the local data processing apparatus 300 includes an update information management unit 207. In addition, the local data processing apparatus 300 stores the update information 222 in the storage unit 220.

The local learning model 210 is updated, for example, when the customer information acquisition unit 201 acquires new customer data. Alternatively, when the business customer data 221 is updated, the local learning model 210 may be updated accordingly.

When the local learning model 210 is updated, the update information management unit 207 manages the version information or the update date and time of the local learning model 210 by updating the update information 222 stored in the storage unit 220. The update information management unit 207 may have a function of notifying the data processing apparatus 130 that the local learning model 210 has been updated.

The update information 222 stored in the storage unit 220 may store the version information of the local learning model 210 or may store the latest update date and time of the local learning model 210.

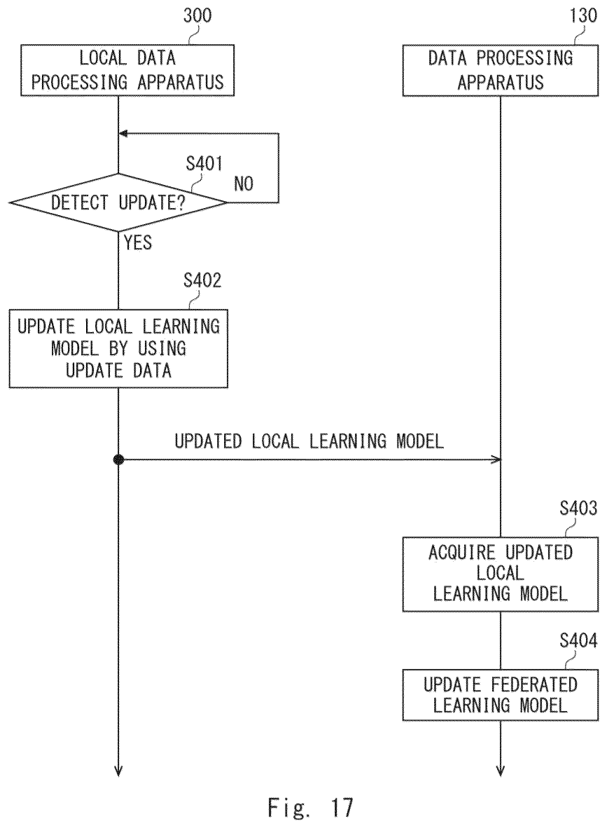

Next, update processing executed by the data processing system 1 will be described with reference to FIG. 17. FIG. 17 is a sequence diagram of an update method according to the third example embodiment.

First, the update information management unit 207 of the local data processing apparatus 300 determines whether the customer information or the business customer data 221 has been updated (step S401). If it is determined that the customer information or the business customer data 221 is not updated (step S401: NO), the local data processing apparatus 300 repeats step S401. If it is determined that the customer information or the business customer data 221 has been updated (step S401: YES), the local data processing apparatus 300 updates the local learning model 210 by using the update data (step S402).

Next, the data processing apparatus 130 acquires the updated local learning model 210 from the local data processing apparatus 300 (step S403).

Next, the data processing apparatus 130 updates the federated learning model 112 by using the updated local learning model 210 (step S404).

The processing in which the data processing apparatus 130 updates the federated learning model by using the updated local learning model has been described above. The data processing system 1 according to the present example embodiment can suitably contribute to marketing activities by appropriately updating the federated learning model 112. Therefore, according to the present example embodiment, it is possible to provide a federated learning model that easily and suitably contributes to marketing activities, a generation apparatus thereof, a data processing apparatus using the federated learning model, and the like.

### Example of Hardware Configuration

Hereinafter, a case where each functional component of the determination apparatus in the present disclosure is implemented by a combination of hardware and software will be described.

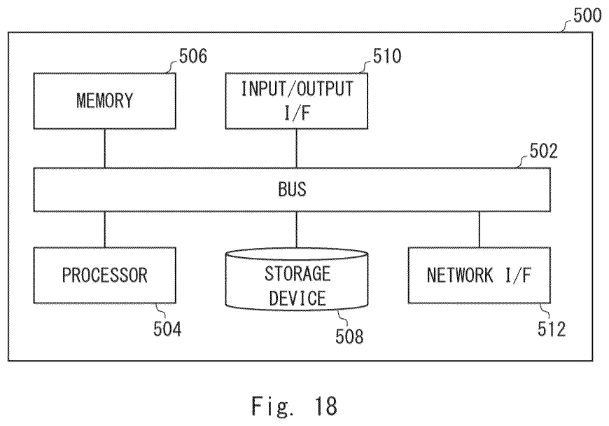

FIG. 18 is a block diagram illustrating a hardware configuration of a computer. A management apparatus in the present disclosure can realize the above-described functions by using a computer 500 having the hardware configuration illustrated in the diagram. The computer 500 may be a portable computer such as a smartphone or a tablet terminal, or may be a stationary computer such as a PC. The computer 500 may be a dedicated computer designed to implement each apparatus, or may be a general-purpose computer. The computer 500 can realize a desired function by installing a predetermined program.

The computer 500 includes a bus 502, a processor 504, a memory 506, a storage device 508, an input/output interface 510 (the interface will also be referred to as an I/F (interface)), and a network interface 512. The bus 502 is a data transmission path for the processor 504, the memory 506, the storage device 508, the input/output interface 510, and the network interface 512 to transmit and receive data to and from each other. However, the method of connecting the processor 504 and the like to each other is not limited to the bus connection.

The processor 504 is various processors such as a CPU, a GPU, or an FPGA. The memory 506 is a primary storage device realized by using a random access memory (RAM) or the like.

The storage device 508 is an auxiliary storage device implemented by using a hard disk, an SSD, a memory card, a read only memory (ROM), or the like. The storage device 508 stores a program for realizing a desired function. The processor 504 reads the program to the memory 506 and executes the program to realize each functional constituent unit of each apparatus.

The input/output interface 510 is an interface connecting the computer 500 and an input/output apparatus. For example, an input apparatus such as a keyboard and an output apparatus such as a display apparatus are connected to the input/output interface 510.

The network interface 512 is an interface connecting the computer 500 to a network.

Although the example of the hardware configuration in the present disclosure has been described above, the example embodiments described above are not limited thereto. According to the present disclosure, any processing can also be implemented by causing a processor to execute a computer program.

In the above-described example, the program includes a group of instructions (or software code) for causing a computer to execute one or more functions described in the example embodiments when being read by the computer. The program may be stored in a non-transitory computer-readable medium or a tangible storage medium. As an example and not by way of limitation, a computer readable medium or tangible storage medium includes a random-access memory (RAM), a read-only memory (ROM), a flash memory, a solid-state drive (SSD) or other memory technology, a CD-ROM, a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer readable medium or a communication medium. As an example and not by way of limitation, transitory computer readable medium or communication medium include electrical, optical, acoustic, or other forms of propagated signals.

Although the invention of the present application has been described above with reference to the example embodiments, the invention of the present application is not limited to the above. Various modifications that can be understood by those skilled in the art can be made to the configuration and details of the invention of the present application within the scope of the invention.

Some or all of the above example embodiments may be described as the following supplementary notes, but are not limited to the following.

### (Supplementary Note 1)

A federated learning model generation apparatus comprising:
a local learning model acquisition unit configured to acquire a plurality of different local learning models that have learned a relationship between a plurality of customer groups respectively generated from business customer data owned by a plurality of business operators and consumption behaviors corresponding to the business operators; and
a federated learning model generation unit configured to receive a predetermined consumption behavior of a customer as input data by federating at least a part of the acquired local learning models, and generate a federated learning model that outputs prospective customer data for the input data.

### (Supplementary Note 2)

The federated learning model generation apparatus according to supplementary note 1, wherein the federated learning model generation unit generates the federated learning model that outputs the prospective customer data including at least a part of the plurality of customer groups.

### (Supplementary Note 3)

The federated learning model generation apparatus according to supplementary note 2, wherein the federated learning model generation unit generates the federated learning model that outputs the prospective customer data including an estimated purchase index indicating a tendency of the consumption behaviors of the customer groups.

### (Supplementary Note 4)

The federated learning model generation apparatus according to supplementary note 3, wherein, when receiving a customer group as an input, the local learning model acquisition unit acquires the local learning models that output the consumption behaviors corresponding to the customer group.

### (Supplementary Note 5)

The federated learning model generation apparatus according to supplementary note 3, wherein, when receiving a consumption behavior of a business operator as an input, the local learning model acquisition unit acquires the local learning models that output the customer groups corresponding to the consumption behavior.

### (Supplementary Note 6)

The federated learning model generation apparatus according to supplementary note 1, wherein the federated learning model generation unit generates the federated learning model by federating at least a part of features extracted for each of the local learning models.

### (Supplementary Note 7)

The federated learning model generation apparatus according to any one of supplementary notes 1 to 6, wherein the local learning model acquisition unit acquires the local learning models learned on a basis of the business customer data including a common region commonly possessed by the plurality of business operators and a unique region possessed by each of the plurality of business operators.

### (Supplementary Note 8)

The federated learning model generation apparatus according to supplementary note 7, wherein the local learning model acquisition unit acquires the local learning models learned on a basis of the business customer data including the customer group as the common region.

### (Supplementary Note 9)

The federated learning model generation apparatus according to supplementary note 8, wherein the local learning model acquisition unit acquires the local learning models each having, as the common region, data in which customers are classified into a plurality of groups as the customer group on a basis of a predetermined attribute regarding each customer.

### (Supplementary Note 10)

A federated learning model generation system comprising:
a local data processing apparatus configured to generate a local learning model for each of business operators on a basis of business customer data managed by each business operator; and
the federated learning model generation apparatus according to claim 7 configured to acquire the local learning models from a plurality of the business operators to generate the federated learning mode.

### (Supplementary Note 11)

The federated learning model generation system according to supplementary note 10, further comprising:
update control unit for controlling to acquire, when any local learning model is updated, the updated local learning model and update the federated learning model using the updated local learning model.

### (Supplementary Note 12)

A federated learning model generation method of causing a computer to perform:
acquiring a plurality of different local learning models that have learned a relationship between a plurality of customer groups respectively generated from business customer data owned by a plurality of business operators and consumption behaviors corresponding to the business operators; and
receiving a predetermined consumption behavior of a customer as input data by federating at least a part of the acquired local learning models, and generating a federated learning model that outputs prospective customer data for the input data.

### (Supplementary Note 13)

A program for causing a computer to perform a federated learning model generation method comprising:
acquiring a plurality of different local learning models that have learned a relationship between a plurality of customer groups respectively generated from business customer data owned by a plurality of business operators and consumption behaviors corresponding to the business operators; and
receiving a predetermined consumption behavior of a customer as input data by federating at least a part of the acquired local learning models, and generating a federated learning model that outputs prospective customer data for the input data.

### (Supplementary Note 14)

A federated learning model generated by federating a plurality of different local learned models, comprising:
at least a part of features of each of local learning models for a plurality of different business operators, the local learning models having learned a relationship between business customer data respectively managed by the plurality of different business operators and a predetermined consumption behavior on a basis of the business customer data,
wherein, when receiving input data on the predetermined consumption behavior, the federated learning model is set to be capable of outputting prospective customer data for the input data, and
wherein the business customer data and the prospective customer data each include a customer group common to the business customer data and the prospective customer data.

This application claims priority based on Japanese Patent Application No. 2022 089722 filed Jun. 1, 2022, the entire disclosure of which is incorporated herein.

### INDUSTRIAL APPLICABILITY

The present disclosure can be used, for example, as a data processing apparatus for a business operator to perform marketing activities.

### REFERENCE SIGNS LIST

1 DATA PROCESSING SYSTEM
2 FEDERATED LEARNING MODEL GENERATION SYSTEM
100 FEDERATED LEARNING MODEL GENERATION APPARATUS
101 LOCAL LEARNING MODEL ACQUISITION UNIT
102 FEDERATED LEARNING MODEL GENERATION UNIT
110 DATA PROCESSING APPARATUS
111 INPUT UNIT
112 FEDERATED LEARNING MODEL
113 OUTPUT UNIT
114 COMMUNICATION UNIT
115 UPDATE CONTROL UNIT
120 DATA PROCESSING APPARATUS
130 DATA PROCESSING APPARATUS
200 LOCAL DATA PROCESSING APPARATUS
201 CUSTOMER INFORMATION ACQUISITION UNIT
202 BUSINESS CUSTOMER DATA GENERATION UNIT
203 LOCAL LEARNING MODEL GENERATION UNIT
204 COMMUNICATION UNIT
205 OPERATION RECEPTION UNIT
206 INFORMATION PRESENTATION UNIT
207 UPDATE INFORMATION MANAGEMENT UNIT
210 LOCAL LEARNING MODEL
220 STORAGE UNIT
221 BUSINESS CUSTOMER DATA
222 UPDATE INFORMATION
300 LOCAL DATA PROCESSING APPARATUS
500 COMPUTER
504 PROCESSOR
506 MEMORY
508 STORAGE DEVICE
510 INPUT/OUTPUT INTERFACE
512 NETWORK INTERFACE
A10 READABLE REGION
G10 GUIDE IMAGE
G11 FIRST GUIDE IMAGE
G12 SECOND GUIDE IMAGE
N1 NETWORK
P1 CUSTOMER
P2 CUSTOMER
D10 CUSTOMER INFORMATION
D11 CUSTOMER STATISTICAL DATA

What is claimed is:

1. A federated learning model generation apparatus comprising:
at least one memory storing instructions; and
at least one processor configured to execute the instructions to:
acquire a plurality of different local learning models that have learned a relationship between a plurality of customer groups respectively generated from business customer data owned by a plurality of business operators and consumption behaviors corresponding to the business operators; and
receive a predetermined consumption behavior of a customer as input data by federating at least a part of the acquired local learning models, and generate a federated learning model that outputs prospective customer data for the input data.

2. The federated learning model generation apparatus according to claim 1, wherein the at least one processor is configured to execute the instructions to generate the federated learning model that outputs the prospective customer data including at least a part of the plurality of customer groups.

3. The federated learning model generation apparatus according to claim 2, wherein the at least one processor is configured to execute the instructions to generate the federated learning model that outputs the prospective customer data including an estimated purchase index indicating a tendency of the consumption behaviors of the customer groups.

4. The federated learning model generation apparatus according to claim 3, wherein, when receiving a customer group as an input, the at least one processor is configured to execute the instructions to acquire the local learning models that output the consumption behaviors corresponding to the customer group.

5. The federated learning model generation apparatus according to claim 3, wherein, when receiving a consumption behavior of a business operator as an input, the at least one processor is configured to execute the instructions to acquire the local learning models that output the customer groups corresponding to the consumption behavior.

6. The federated learning model generation apparatus according to claim 1, wherein the at least one processor is configured to execute the instructions to generate the federated learning model by federating at least a part of features extracted for each of the local learning models.

7. The federated learning model generation apparatus according to claim 1, wherein the at least one processor is configured to execute the instructions to acquire the local learning models learned on a basis of the business customer data including a common region commonly possessed by the plurality of business operators and a unique region possessed by each of the plurality of business operators.

8. The federated learning model generation apparatus according to claim 7, wherein the at least one processor is configured to execute the instructions to acquire the local learning models learned on a basis of the business customer data including the customer group as the common region.

9. The federated learning model generation apparatus according to claim 8, wherein the at least one processor is configured to execute the instructions to acquire the local learning models each having, as the common region, data in which customers are classified into a plurality of groups as the customer group on a basis of a predetermined attribute regarding each customer.

10. A federated learning model generation system comprising:
a local data processing apparatus configured to generate a local learning model for each of business operators on a basis of business customer data managed by each business operator; and
the federated learning model generation apparatus according to claim 7 configured to acquire the local learning models from a plurality of the business operators to generate the federated learning mode.

11. The federated learning model generation system according to claim 10, further comprising:
an update control unit configured to control to acquire, when any local learning model is updated, the updated local learning model and update the federated learning model using the updated local learning model.

12. A federated learning model generation method of causing a computer to perform:
acquiring a plurality of different local learning models that have learned a relationship between a plurality of customer groups respectively generated from business customer data owned by a plurality of business operators and consumption behaviors corresponding to the business operators; and
receiving a predetermined consumption behavior of a customer as input data by federating at least a part of the acquired local learning models, and generating a federated learning model that outputs prospective customer data for the input data.

13-14. (canceled)
